(19) United States
(12) Patent Application Publication
(10) Pub. No.: US 2015/0186855 A1
(43) Pub. Date: Jul. 2, 2015

(54) ELECTRONIC INVOICING AND PAYMENT

(71) Applicant: Invoice Cloud Incorporated, Braintree, MA (US)

(72) Inventors: Robert Bennett, Boston, MA (US); Robert Lapides, Walpole, MA (US); John Morabito, Vienna, VA (US); Kelton Averyt, Rancho Viejo, TX (US)

(21) Appl. No.: 14/144,836

(22) Filed: Dec. 31, 2013

(51) Int. Cl. G06Q 20/10; G06Q 20/42

(52) U.S. Cl. CPC G06Q 20/102; G06Q 20/42

(57) ABSTRACT

A method includes, for each of multiple billers, maintaining, at a payment system, a transaction record for each of one or more transactions for the biller, each transaction having been executed by or on behalf of a customer through a user interface of the payment system. The method includes updating, at the payment system, a confirmation status of a particular transaction record for a particular biller based on a confirmation received from the particular biller.

### CROSS-REFERENCE TO RELATED APPLICATIONS

This application is related to U.S. Patent Publication No. 2011/0270749, filed Apr. 29, 2011; and to U.S. patent application Ser. No. 13/890,792, filed May 9, 2013; and to U.S. patent application Ser. No. 14/069,034, filed Oct. 31, 2013, the entire contents of all of which are incorporated here by reference.

### BACKGROUND

Before the advent of computers, when an entity, such as a landlord or a municipality, would present a bill to an individual or another entity, this bill was generally in paper form and would be hand delivered or mailed to the payer. In most instances, the payer would directly pay the bill by presenting the biller with cash or a check. Alternatively, if the biller was a merchant, the payer could present a credit card to the merchant. The credit card issuing company would then present a bill to the payer which would generally be paid by a check.

The utilization of computers and emails has changed the method in which payments can be made between the biller and the payer. The biller can establish an automated system between the payer and the payer's banking institution which will automatically deduct the payment from the payer's account. Additionally, computer systems allow for the payment between the payer and the biller utilizing an electronic check. This payment process can be inefficient, particularly when multiple payments or invoices are due.

### SUMMARY

In a general aspect, a method includes, for each of multiple billers, maintaining, at a payment system, a transaction record for each of one or more transactions for the biller, each transaction having been executed by or on behalf of a customer through a user interface of the payment system. The method includes updating, at the payment system, a confirmation status of a particular transaction record for a particular biller based on a confirmation received from the particular biller.

Embodiments may include one or more of the following features.

The method includes sending, to the particular biller, transaction data for the transaction corresponding to the particular transaction record. In some cases, the method includes receiving the confirmation from the particular biller responsive to the sent transaction data. In some cases, the method includes sending the transaction data upon execution of the transaction. In some cases, the transaction data includes at least some of the data in the transaction record for the transaction.

The confirmation is indicative of whether the biller received transaction data for the transaction corresponding to the particular transaction record.

The confirmation is indicative of an error associated with the particular transaction record or the transaction corresponding to the particular transaction record. In some cases, the error includes that the transaction is a duplicate transaction or that the transaction record is a duplicate transaction record.

The method includes providing, to a customer service representative, information indicative of the confirmation status of the particular transaction.

In a general aspect, a computer readable storage medium stores instructions for causing a computing system to, for each of multiple billers, maintain, at a payment system, a transaction record for each of one or more transactions for the biller, each transaction having been executed by or on behalf of a customer through a user interface of the payment system; and update, at the payment system, a confirmation status of a particular transaction record for a particular biller based on a confirmation received from the particular biller.

Embodiments may include one or more of the following features.

The instructions cause the computing system to send, to the particular biller, transaction data for the transaction corresponding to the particular transaction record. In some cases, the instructions cause the computing system to receive the confirmation from the particular biller responsive to the sent transaction data. In some cases, the instructions cause the computing system to send the transaction data upon execution of the transaction.

In a general aspect, a computing system includes a processor coupled to a memory. The processor and memory are configured to, for each of multiple billers, maintain, at a payment system, a transaction record for each of one or more transactions for the biller, each transaction having been executed by or on behalf of a customer through a user interface of the payment system; and update, at the payment system, a confirmation status of a particular transaction record for a particular biller based on a confirmation received from the particular biller.

Embodiments may include one or more of the following features.

The processor and memory are configured to send, to the particular biller, transaction data for the transaction corresponding to the particular transaction record. In some cases, the processor and memory are configured to receive the confirmation from the particular biller responsive to the sent transaction data. In some cases, the processor and memory are configured to send the transaction data upon execution of the transaction.

In a general aspect, a method includes, for each of multiple billers, maintaining, at a payment system, a transaction record for each of one or more transactions for the biller, each transaction having been executed by a customer through a user interface of the payment system. The method includes enabling display, to or for the benefit of a particular biller, one or more of the transaction records for the particular biller.

Embodiments may include one or more of the following features.

Enabling display of the transaction records comprises enabling display of the transaction records to or for the benefit of the particular biller and not to or for the benefit of any other of the multiple billers.

Enabling display of the transaction records comprises enabling the transaction records to be displayed within a third party software interface.

Enabling display of the transaction records comprises enabling an interaction with the transaction records on behalf of the particular biller.

Each transaction record includes a confirmation status for the corresponding transaction. In some cases, enabling display of the transaction records includes enabling display of the confirmation status for each transaction record. In some cases, enabling display of the transaction records includes enabling sorting of the transaction records by confirmation status. In some cases, the confirmation status is based on a confirmation received from or on behalf of the biller of the corresponding transaction. In some cases, the confirmation received from or on behalf of the biller is indicative of whether the biller received transaction data for the corresponding transaction. In some cases, the confirmation received from or on behalf of the biller is indicative of an error associated with the corresponding transaction.

In a general aspect, a computer readable storage medium stores instructions for causing a computing system to, for each of multiple billers, maintain, at a payment system, a transaction record for each of one or more transactions for the biller, each transaction having been executed by a customer through a user interface of the payment system; and enable display, to or for the benefit of a particular biller, one or more of the transaction records for the particular biller.

Embodiments may include one or more of the following features.

Enabling display of the transaction records comprises enabling display of the transaction records to or for the benefit of the particular biller and not to or for the benefit of any other of the multiple billers.

Enabling display of the transaction records comprises enabling the transaction records to be displayed within a third party software interface.

Enabling display of the transaction records comprises enabling an interaction with the transaction records on behalf of the particular biller.

Enabling display of the transaction records includes enabling display of a confirmation status for each transaction record.

Enabling display of the transaction records includes enabling sorting of the transaction records by a confirmation status for each transaction record.

In a general aspect, a computing system includes a processor coupled to a memory. The processor and memory are configured to, for each of multiple billers, maintain, at a payment system, a transaction record for each of one or more transactions for the biller, each transaction having been executed by a customer through a user interface of the payment system; and enable display, to or for the benefit of a particular biller, one or more of the transaction records for the particular biller.

Embodiments may include one or more of the following features.

Enabling display of the transaction records comprises enabling display of the transaction records to or for the benefit of the particular biller and not to or for the benefit of any other of the multiple billers.

Enabling display of the transaction records comprises enabling the transaction records to be displayed within a third party software interface.

Enabling display of the transaction records comprises enabling an interaction with the transaction records on behalf of the particular biller.

Enabling display of the transaction records includes enabling display of a confirmation status for each transaction record.

Enabling display of the transaction records includes enabling sorting of the transaction records by a confirmation status for each transaction record.

In a general aspect, a method includes receiving transaction data for a transaction executed by or on behalf of a customer through a user interface of a payment system; and sending, to the payment system, a confirmation in response to receiving the transaction data.

Embodiments may include one or more of the following features.

The confirmation is indicative of receipt of the transaction data.

The confirmation is indicative of an error associated with the transaction data.

The method includes evaluating a validity of the received transaction data. In some cases, the confirmation is indicative of the validity of the received transaction data. In some cases, evaluating the validity of the received transaction data comprises evaluating the received transaction data in view of stored transaction data.

The method includes storing the received transaction data.

In a general aspect, a computer readable storage medium stores instructions for causing a computing system to receive transaction data for a transaction executed by or on behalf of a customer through a user interface of a payment system; and send, to the payment system, a confirmation in response to receiving the transaction data.

Embodiments may include one or more of the following features.

The instructions cause the computing system to evaluate a validity of the received transaction data, and wherein the confirmation is indicative of the validity of the received transaction data.

The instructions cause the computing system to store the received transaction data.

In a general aspect, a computing system includes a processor coupled to a memory. The processor and memory are configured to receive transaction data for a transaction executed by or on behalf of a customer through a user interface of a payment system; and send, to the payment system, a confirmation in response to receiving the transaction data.

Embodiments may include one or more of the following features.

The processor and memory are configured to evaluate a validity of the received transaction data, and wherein the confirmation is indicative of the validity of the received transaction data.

The processor and memory are configured to store the received transaction data.

In a general aspect, a method includes receiving, from a payment system, a transaction record for each of one or more transactions for a biller, each transaction having been executed by a customer through the payment system; and displaying one or more of the transaction records on a user interface.

Embodiments may include one or more of the following features.

Each transaction record includes a confirmation status for the corresponding transaction. In some cases, displaying one or more of the transaction records includes displaying the confirmation status for each transaction record. In some cases, the confirmation status is based on a confirmation status is based on a confirmation received from or on behalf of the biller. In some cases, the confirmation status is indicative of whether the biller received transaction data for the corresponding transaction. In some cases, the confirmation status is indicative of an error associated with the corresponding transaction. In some cases, displaying one or more of the transaction records includes displaying transaction records having a particular confirmation status.

Displaying one or more of the transaction records includes displaying transaction records for transactions executed by or on behalf of a particular customer or transaction records for transactions corresponding to a particular customer account identifier.

The method includes requesting the transaction records from the payment system. In some cases, requesting the transaction records includes requesting transaction records for transactions executed by or on behalf of a particular customer or transaction records for transactions corresponding to a particular customer account identifier. In some cases, requesting the transaction records includes requesting transaction records having a particular confirmation status.

In a general aspect, a computer readable storage medium stores instructions for causing a computing system to receive, from a payment system, a transaction record for each of one or more transactions for a biller, each transaction having been executed by a customer through the payment system; and display one or more of the transaction records on a user interface.

Embodiments may include one or more of the following features.

The instructions cause the computing system to display one or more of the transaction records includes displaying a confirmation status for each transaction record.

The instructions cause the computing system to display one or more of the transaction records includes displaying transaction records having a particular confirmation status.

The instructions cause the computing system to display one or more of the transaction records includes displaying transaction records for transactions executed by or on behalf of a particular customer or transaction records for transactions corresponding to a particular customer account identifier.

The instructions cause the computing system to request the transaction records from the payment system.

In a general aspect, a computing system includes a processor coupled to a memory. The processor and memory are configured to receive, from a payment system, a transaction record for each of one or more transactions for a biller, each transaction having been executed by a customer through the payment system; and display one or more of the transaction records on a user interface.

Embodiments may include one or more of the following features.

The processor and memory are configured to display one or more of the transaction records includes displaying a confirmation status for each transaction record.

The processor and memory are configured to display one or more of the transaction records includes displaying transaction records having a particular confirmation status.

The processor and memory are configured to display one or more of the transaction records includes displaying transaction records for transactions executed by or on behalf of a particular customer or transaction records for transactions corresponding to a particular customer account identifier.

The processor and memory are configured to request the transaction records from the payment system.

These and other aspects, features, and implementations, and combinations of them, can be expressed as methods, apparatus, systems, components, software products, business methods, means and steps for performing functions, and in other ways. Other features and advantages will be apparent from the following description and from the claims.

### DESCRIPTION

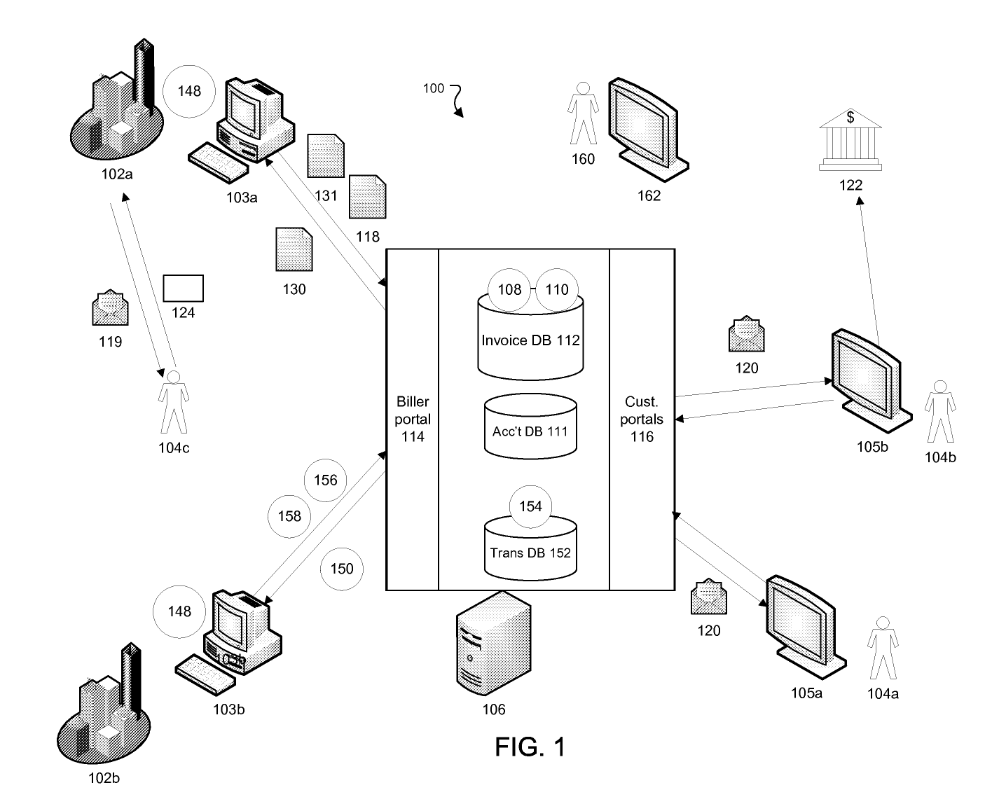

FIG. 1 is a block diagram.

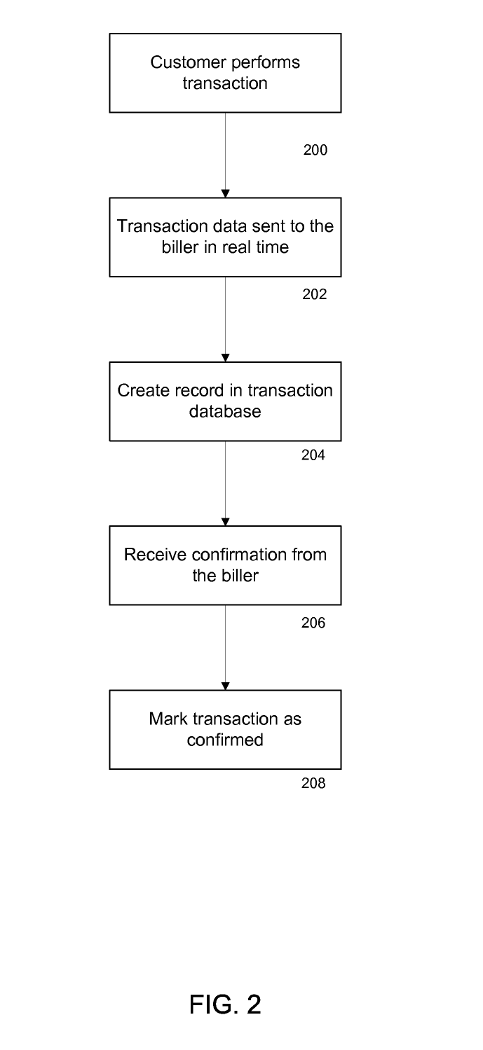

FIG. 2 is a flowchart.

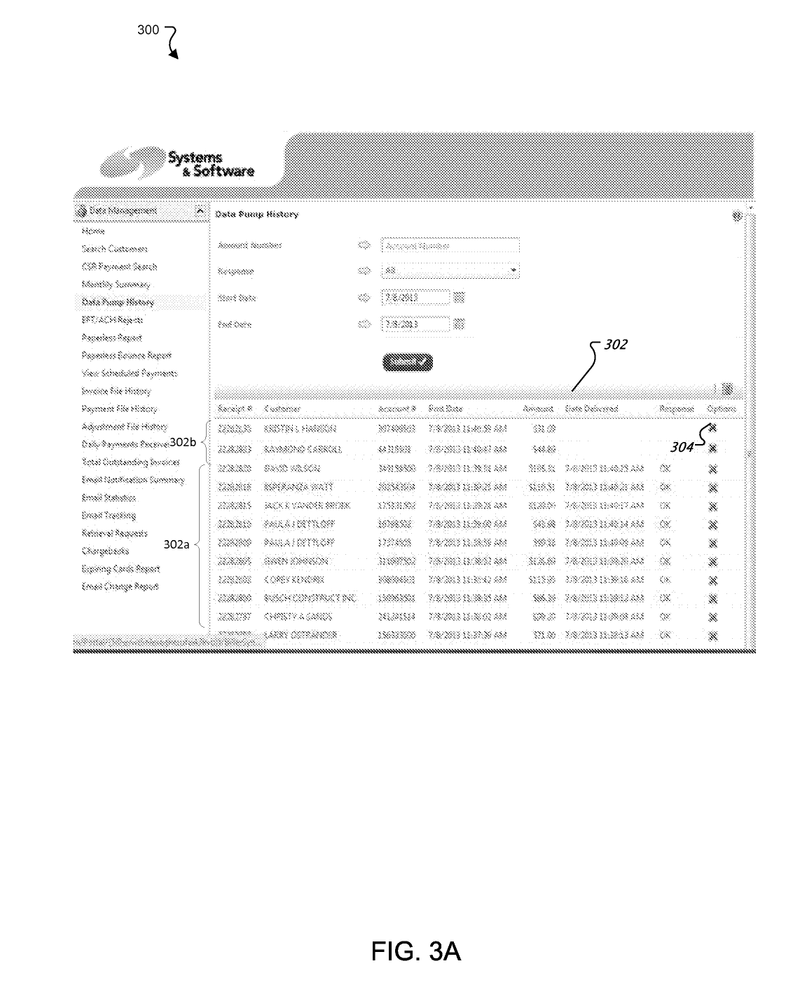

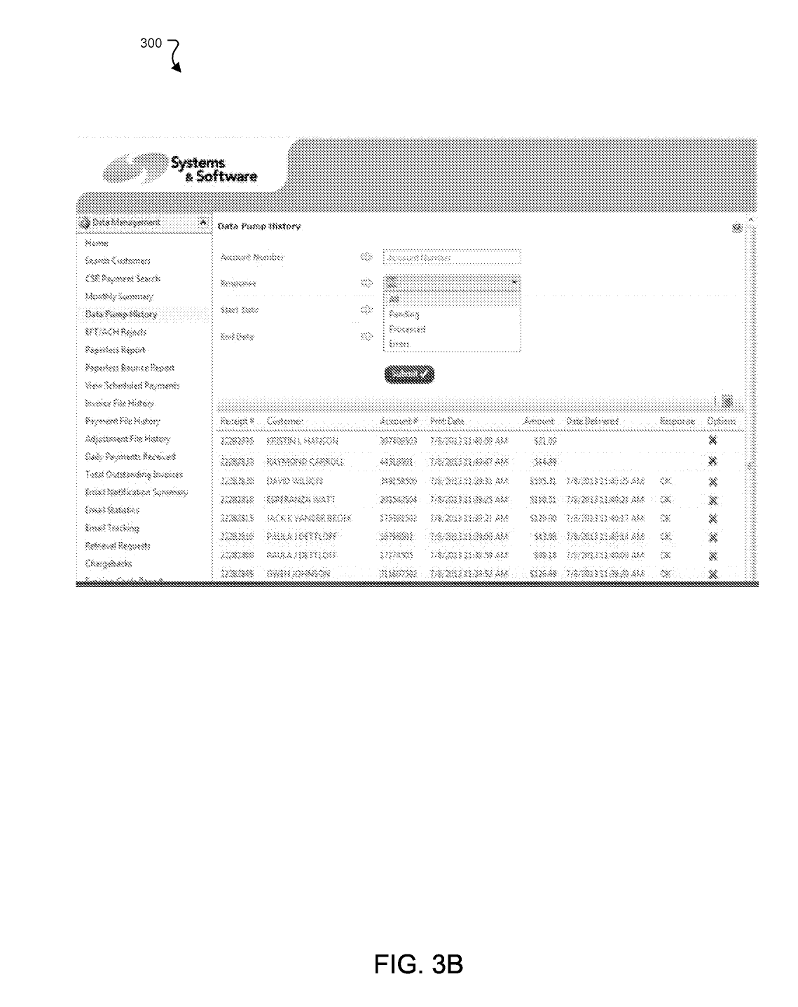

FIGS. 3A and 3B are screenshots.

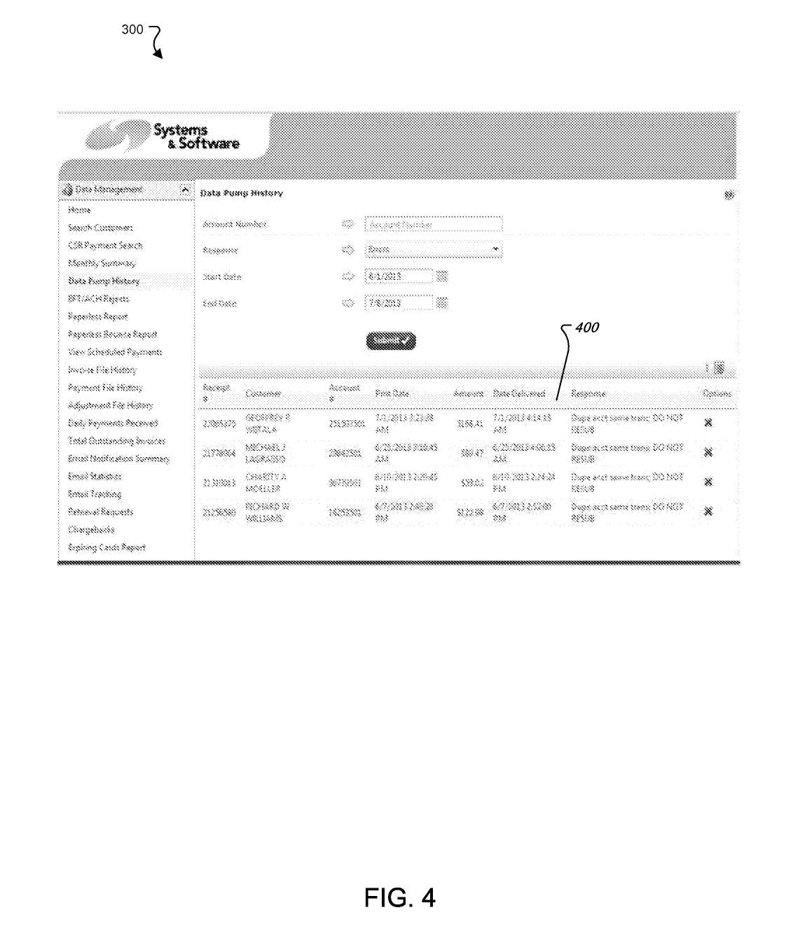

FIG. 4 is a screenshot.

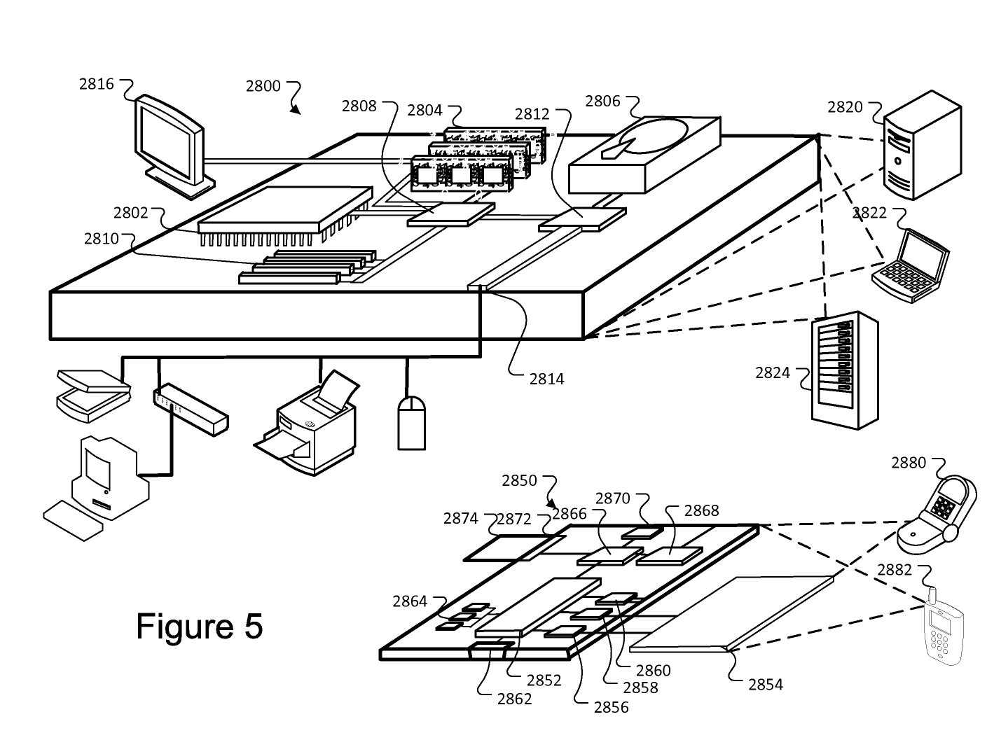

FIG. 5 is a block diagram.

We describe here an electronic invoice and payment system that processes and maintains information about customer transactions, such as payments, on behalf of multiple independent billers. Each biller can use the invoice and payment system to view information about the transactions of its own customers. The information can be displayed in a biller interface administered by the electronic invoice and payment system or can be displayed within the interface of a third party software, such as the biller's billing or accounting software.

The electronic invoice and payment system sends data about each transaction to the corresponding biller substantially in real time, such as immediately after the customer performs the transaction. By a transaction, we mean broadly, for example, any financial interaction a customer performs through the invoice and payment system. A transaction can be, e.g., a payment, an adjustment to an invoice, or another type of financial interaction. The system can track whether the biller has received the data and whether the biller detects an error in the data, such as data representing a duplicate transaction or data that has been corrupted. This tracking of receipt and data validity can be useful to a biller who is attempting to resolve an accounting inquiry, such as an investigation into a transaction that did not correctly post to a customer's account.

Referring to FIG. 1, an electronic invoice and payment system 100 provides billing services on behalf of multiple independent billers 102a, 102b (sometimes referred to collectively as billers 102) and provides payment services to customers 104a, 104b, 104c of the billers (sometimes referred to collectively as customers 104). A centralized server 106 (or multiple centralized servers) enables the electronic invoice and payment system 100 to provide individualized billing services to each of the billers 102. By individualized billing services, we mean broadly, for example, billing services that are provided to and can be customized by, for, or on behalf of each biller independently of the billing services provided to each other biller.

By a biller, we mean broadly, for example, any entity that issues bills to its customers. For instance, a biller can be a utility company that issues electric bills and gas bills. A biller can be a city or town that issues several types of bills, such as water and sewer bills, real estate tax bills, and motor vehicle excise tax bills. A biller can be a property management company that issues rent bills and utility bills. By a bill we mean broadly, for example, any representation that is presented to a party in any form and refers to an amount due. By customers, we mean broadly, for example, the people or entities that receive the bills, pay the bills, or both. For instance, customers of a city can include residents of the city, landlords who own property in the city, and businesses operating in the city. Customers of a property management company can include tenants in buildings operated by the property management company.

By independent billers, we mean broadly, for example, billers that issue bills to customers independently of any other biller. In some examples, the biller 102a and the biller 102b can be two independent, unrelated entities, such as the city of Cambridge, Mass., and the Tucson Municipal Light Department. In some examples, the biller 102a and the biller 102b can be two independent billers each providing a different service for the same entity. For instance, the biller 102a and the biller 102b can be the water department and the transfer station, respectively, for the city of Boston. In some examples, the invoice and payment system 100 can provide one or more different individualized billing services for a single biller to allow for the biller to provide various products, serve various markets, or for other purposes. For instance, the biller 102a can be New York City and different billing services can be provided for each type of bill issued by New York City, such as water bills, real estate tax bills, and motor vehicle excise tax bills.

Invoice data 108 and transaction data 110 for each biller 102 are maintained in an invoice database 112 hosted by the centralized server 106. Invoice data 108 for a particular biller can include, for each customer of the biller, an amount due, a due date, an invoice number, an account number, or other information, or a combination of any two or more of them, for each type of invoice (we sometimes use the word invoice interchangeably with bill) issued by the biller. The invoice database maintains invoice data 108 and transaction data 110 for all of the independent billers.

A particular biller may issue more than one type of bill. For example, a city may issue various types of tax bills, water and sewer bills, bills for civil fines, bills for dog licenses, and other types of bills. Transaction data 110 for each biller 102 can include records of payments toward each invoice of each customer 104 of the biller 102, including, for each payment, the amount and date of the payment, the account number or invoice number to which the payment was applied, the receipt number for the payment, the name of the customer, or other information, or a combination of any two or more of them. The total of the payments included in the transaction data 110 is credited to the biller's account in an account database 111.

The electronic invoice and payment system 100 provides a biller portal 114, typically separate from the customer portal, through which each biller can control (independently of any other biller) the experience of its own customers. By experience, we mean broadly, for example, the simplicity or complexity, richness of features, speed, accuracy, privacy, and other features of the portal that contribute to the look and feel of the portal and the process of using it. The biller portal 114 for each biller 102 is separate and independent from the biller portal 114 for each other biller 102. Each biller 102a, 102b accesses the biller portal 114 through a network connection, such as the Internet, or other communication channel, between a respective computing device 103a, 103b and the centralized server 106 of the electronic invoice and payment system 100. The biller portal can be implemented as a website served from centralized Web servers through the Web to the biller.

By using features available on the biller portal 114, each biller 102 can create one or more independently customized, branded customer portals 116 that can be accessed by its customers 102a, 102b through computing devices 105a, 105b. That is, for instance, each biller 102 can set up one or more customer portals 116 that each operates independently of each other customer portal for the same biller 102 or for other billers. By independently customized, we mean broadly, for example, that each biller 102 can specify features for its own customer portal 116 and business rules for transactions performed through its own customer portal 116 independently of the specified features and business rules for the customer portal 116 of each other biller 102. For instance, each biller 102 can specify features such as, e.g., the name of the biller, a logo or motto of the biller, an address or phone number of the biller, colors associated with the biller, other features specific to the biller, or a combination of any two or more of these features.

Each biller 102 can also use the biller portal 114 to set business rules related to customer transactions (e.g., payments, bill adjustments, or other transactions), customer communications, payment processing, or other features, or a combination of any two or more of them, independently from each other biller. By business rules, we mean broadly, for example, any principles, guidelines, procedures, or other aspects of how an entity conducts or intends to conduct its operations internally and its relationships with other parties. Business rules can include, e.g., whether partial payments or overpayments are allowed, whether a payment for an invoice can be split among multiple payment methods, when a late fee is to be charged, or other business rules.

Each biller 102 can use the biller portal 114 to independently customize the presentation of invoices to its customers 104. For instance, if a biller 102 issues multiple invoices of one type or multiple types of invoices or both to its customers 104, the biller 102 can aggregate some or all of these multiple invoices into a single overall invoice. A single invoice can be easier for a customer 104 to pay than multiple disparate invoices, and thus the ability to present a single invoice can help to increase collections yield for the biller 102. For instance, a biller 102 who is a landlord may generate a single monthly invoice including a rent bill and bills for utilities, such as water, electric, and gas, that are initially billed to the landlord from the utility company.

Therefore, through the biller portal, each of multiple independent billers can manage and configure a wide variety of aspects of one or more customer portals, including the look and feel, branding, functional features, business rules, and other characteristics of each of the customer portals.

Other features of the biller portal 114 can also be customized, for instance, as described in U.S. Patent Pub. No. 2011/0270749, and U.S. patent application Ser. No. 13/890,792, the contents of both of which are incorporated here by reference in their entirety.

When a biller (e.g., the biller 102a) issues invoices, an invoice file 118 is uploaded from the biller's computing device 103a to the electronic invoice and payment system 100. The invoice file 118 is stored in the invoice database 112. For each invoice, the invoice file 118 can include information about, e.g., the type of invoice (e.g., an electric bill), the amount due on the invoice, the due date of the invoice, the customer of the invoice (e.g., a name, address, customer identifier, or a combination of any two or more of them), an invoice number, an account number, or other information about the invoice, or a combination of any two or more of them.

In some examples, customers 104 receive emails 120 from the electronic invoice and payment system 100 alerting them that invoices have been issued by the biller 102. The customers 104 can select links in the emails 120 to view the invoices in the customer portal 116. In some examples, some or all of a biller's customers 104 (e.g., customers not enrolled in paperless billing) receive paper invoices 119 mailed to them from or on behalf of the billers 102.

Through the customer portal 116, a customer 104 can view an invoice, pay an invoice, or both. The customer 104 may be presented with several payment options for paying the invoice, depending on the business rules established by the biller issuing the invoice. For instance, the customer 104 may be able to pay the entire amount due on the invoice immediately, make a partial payment immediately, or schedule one or more future payments.

A variety of payment methods can be available to customers 104. Customers (e.g., customer 104a) can pay directly to the electronic invoice and payment system 100 through the customer portal 116, e.g., by providing credit card, debit card, or bank account information (e.g., for automated clearing house (ACH) payments). Customers (e.g., customer 104b) can pay to through an online bill pay service provided through a bank 122 (which we refer to here as “online bank direct payments”). Customers (e.g., customer 104c) can also pay directly to the biller 102a using a paper check 124 or cash, e.g., by mail or in person at a payment window.

In some examples, information about customer transactions for a biller 102 (e.g., biller 102a) can be synchronized between the electronic invoice and payment system 100 and the biller's computing device 103 in batches. For instance, information about transactions can be synchronized at scheduled intervals, e.g., once an hour, twice a day, once a day, or at another interval. The synchronization interval can be a default interval or can be specified by each biller. Synchronization enables records 148 kept by the biller 102a to be updated to reflect customer transactions that were completed directly with the electronic invoice and payment system 100. Synchronization also enables the transaction data 110 for the biller 102a stored in the invoice database 112 to be updated to reflect customer transactions that were completed directly with the biller 102a (e.g., by check, cash, or through an online bank direct payment).

For batch synchronization, a transaction file 130 is sent from the electronic invoice and payment system 100 to the biller's computing device 103a. The transaction file 130 includes data about transactions for the biller 102a that were carried out directly with the electronic invoice and payment system 100 since the previous transaction file 130 was transferred. In addition, a transaction file 131 is sent from the biller's computing device 103a to the electronic invoice and payment system 100. The transaction file 131 includes data about transactions that were carried out directly with the biller 102a since the previous transaction file 131 was transferred. In some examples, the data in the transaction files 130, 131 is checked for errors (e.g., corrupted information, duplicate transactions, missing transactions, or other errors) prior to being sent, upon receipt, or both.

In some examples, a transaction file 130, 131 can include, e.g., one or more of the following fields:
File identifier assigned by the biller.
Date and time the transaction file was created.
Total number of transactions (e.g., payments, adjustments, or both) included in the transaction file.
Total dollar amount of the transactions (e.g., payments, adjustments, or both) included in the transaction file.
Transaction data for each transaction.
Invoice number.
Account number of the customer.
Total amount of the transaction.
Date the transaction was made.
For an adjustment, instructions to make a fixed amount adjustment or a balance differential adjustment.
For an adjustment, description of the adjustment.
Transaction method (e.g., credit card, electronic funds transfer, credit adjustment, check, cash, debit adjustment, or another payment method).
Transaction message provided with a manual or offline transaction.
Transaction reference provided with a manual or offline transaction.
Invoice type.
An installment number of the transaction.
A biller year of the transaction.
A biller bill number used to locate invoices for offline transactions.
Instructions to match the transaction to the oldest invoice or the newest invoice.

In some examples, information about customer transactions for a biller 102 (e.g., biller 102b) can be synchronized between the electronic invoice and payment system 100 and the biller's computing device 103b in real time, e.g., as soon as or soon after the transaction occurs. By real time synchronization, we mean broadly, for example, that information is synchronized between the invoice and payment system 100 and the biller's computing device 103b as each transaction occurs and without waiting for a previously scheduled time for the synchronization. A transaction record 150 including information about a single transaction (e.g., a payment or adjustment) is sent from the electronic invoice and payment system 100 to the biller's computing device 103b when the transaction occurs. The transaction record 150 can include some or all of the same fields as the transaction files 130, 131. For instance, a transaction record 150 reflecting an individual payment for the biller 102b that was carried out directly with the electronic invoice and payment system 100 can be sent to the biller's computing device 103b in real time, e.g., immediately after the payment is made, within 1 second of the payment, within 10 seconds of the payment, within 30 seconds of the payment, or within another brief time period following the payment. As a result, the biller's records 148 can be updated substantially in real time, e.g., as each transaction occurs. In some examples, each biller 102 can select either real time synchronization or batch synchronization, or can select real time synchronization for some time periods (e.g., during business hours) and batch synchronization for other time periods (e.g., not during business hours), or real time synchronization for some class of transactions and simultaneously batch synchronization for some other class of transactions.

A recent transaction database 152 of the electronic invoice and payment system 100 maintains records 154 for all recent transactions for all billers 102 enrolled in real time synchronization. Each record 154 in the recent transaction database 152 corresponds to a particular transaction and also corresponds to a transaction record 150 that was sent to a biller 102 with information about the particular transaction. Each record 154 in the recent transaction database 152 can include some or all of the same fields as the corresponding transaction record 150. For instance, in some instances, each record 154 includes a transaction reference number, a customer name, a customer account number, a transaction date, and a transaction amount. Each record also includes an identifier of the biller for the transaction.

When a transaction record 150 is sent to a biller 102, the corresponding record 154 in the recent transaction database 152 is created and marked as unconfirmed. When the transaction record 150 is received by the biller 102, the biller 102 returns a confirmation 156 to the electronic invoice and payment system 100. Upon receipt of the confirmation 156, the record 154 in the recent transaction database 152 is marked as confirmed. In some examples, a date or time or both at which the confirmation 156 was received can be stored for each confirmed record 154. If no confirmation is received for a transaction record 150, the corresponding record 154 remains unconfirmed in the recent transaction database 152. In some examples, the transaction record 150 corresponding to each unconfirmed record 154 is sent again to the biller 102, e.g., a certain number of times (e.g., two times, five times, or another number of times). In some examples, the transaction record 150 corresponding to each unconfirmed record 154 is sent periodically to the biller 102, e.g., once per minute, once every five minutes, or at another interval). In some examples, no action is taken for unconfirmed transaction records.

In some examples, the biller 102 can evaluate the validity of the transaction record 150, e.g., to ensure that the data are not corrupted, do not represent a duplicate transaction, or meet another metric of validity. In some examples, if the transaction record 150 is invalid, the biller 102 does not return a confirmation 156. In some examples, if the transaction record 150 is invalid, the biller 102 returns an explanation 158 of why the transaction record 150 is invalid. The explanation 158 can be stored in the corresponding record 154 in the recent transaction database 152. In some examples, the electronic invoice and payment system 100 does not itself evaluate the validity of the transaction records 150 and thus is agnostic to the particular metrics of validity used by each biller 102.

In some examples, a record 154 for a transaction can be maintained in the recent transaction database 152 for a period of time after the transaction has been completed, such as one day, one month, one year, or another period of time. The period of time can be a default time or can be specified by the biller. In some examples, a default or biller-specified number of records 154 for each biller can be maintained in the recent transaction database 152. When the specified number of records 154 for a particular biller is reached, the oldest record 154 can be deleted to allow a newer record to be stored in the database 152.

Each biller 102 can view the records 154 for the transactions of its customers 104. For instance, each record 154 in the recent transaction database 152 can include a field or other type of tag identifying the biller. When a particular biller 102 accesses the recent transaction database 152, only those records 154 that identify that particular biller 102 can be viewed. In some examples, a biller 102 can view the records 154 through the biller portal 114. In some examples, the records 154 are displayed within the interface of third party software, such as a billing or accounting software used by the biller 102. Typically, the biller cannot view the records for the transactions of any other biller even though those transactions are maintained in the same recent transaction database 152.

For each record, the biller 102 can see information about the corresponding transaction, whether the transaction is confirmed or unconfirmed, the date and time when the transaction was confirmed, any invalidity explanation associated with the transaction, or other information, or a combination of any two or more of them. The records 154 for each biller 102 are accessible through the biller portal 114 regardless of the details of the corresponding transactions, such as the type of invoice, the validity metrics of the biller 102, or other details, and regardless of the nature of the biller's own billing or recordkeeping software.

Access to the records 154 of the recent transaction database 152 through the biller portal 114 can be useful, e.g., to a customer service representative 160 assisting a customer 104 with a billing question. For instance, in one example situation, a customer 104 calls the city of Providence to look into the status of a payment that he made through the electronic invoice and payment system 100 but that is not reflected in his online account records. The customer service representative 160 notes that the customer's payment does not appear in the biller's records. However, when the customer service representative 160 accesses the biller portal 114 through a computing device 162, he sees an unconfirmed record 154 that corresponds to the customer's payment. Accordingly, the customer service representative 160 can attempt to resolve any issues preventing the record 154 from being confirmed so that the customer's account can be properly credited with his payment.

In another example, a customer 104 whose water service is about to be shut off for nonpayment calls the Worcester Water Department to say that he just paid his outstanding water bill through the electronic invoice and payment system 100. Not enough time has passed since the customer 104 made his payment for the water department's billing records to reflect the payment. However, through the billing portal 114, a customer service representative 160 can see a record 154 that corresponds to the customer's payment and that is still waiting for confirmation. Because the customer service representative 160 can see evidence that the customer 104 has made an appropriate payment, the customer service representative 160 can delay or cancel the shutoff of the customer's water service.

Referring to FIG. 2, in an example process for real time synchronization, a customer makes a payment or performs another transaction through the electronic invoice and payment system (200). For instance, the customer can pay all or part of a single invoice issued by a biller or can pay multiple invoices issued by the same biller.

A transaction record with information about the customer's transaction (e.g., payment) is sent to the biller (202) in real time as the transaction occurs. For instance, the transaction record can be sent immediately after the payment is made, within 1 second of the payment, within 10 seconds of the payment, within 30 seconds of the payment, or within another time period following the payment. The transaction record can include information such as the total amount of the transaction, the time and date of the transaction, the customer's name, the customer's account number, the invoice number, the transaction method (credit card, electronic funds transfer, credit adjustment, check, cash, debit adjustment, or another payment method), a transaction reference number, or other information, or a combination of any two or more of them.

A record in the recent transaction database is created for the customer's transaction (204). The record is initially marked as unconfirmed. The record in the recent transaction database can include some or all of the same information that is included in the transaction record sent to the biller. For instance, the record in the recent transaction database can include a transaction reference number, a customer name, a customer account number, a transaction date, and a transaction amount.

When a confirmation is received from the biller (206), the record for the customer's transaction is marked as confirmed (208). If no confirmation is received from the biller, the record remains marked as unconfirmed. In some examples the transaction record is sent one or more additional times to the biller, e.g., a set number of times or until a confirmation is received. In some examples, if the transaction record is invalid, an explanation of the invalidity of the record is received from the biller.

Referring to FIG. 3A, an example records view 300 shows records 302 stored in the transaction database for several transactions for a biller that occurred on Jul. 8, 2013. A confirmation date and a biller response (e.g., “OK”) are stored for each confirmed record 302a. A flag 304 indicates records 302b that have not yet been confirmed by the biller. In this example, although the records view 300 is operated by the electronic invoice and payment system, the interface is graphically branded to match the visual appearance of the biller's billing software.

Referring to FIG. 3B, through the records view 300, a user can search records in the database by one or more features of the records. For instance, the records can be searched by account number to identify all records in the transaction database that are associated with a particular account number. The records can be search by confirmation status, such as pending records, processed (confirmed) records, or records with errors. The records can be searched by date. Other search criteria can also be used.

Referring to FIG. 4, four records 400 are displayed in the records view 300 in response to a search for records with errors. In this example, the four records 400 reflect duplicate transactions, meaning a transaction that was incorrectly sent twice to the biller. The review capability provided by the records view 300 of the biller portal allows billers to review and detect duplicate transactions and other types of errors, making it less likely that such duplicate transactions are double counted in the biller's accounting system.

FIG. 5 shows an example of a personal computing device 500 and a mobile device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided to communicate with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided through the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, and so forth) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used here, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

What is claimed is:

1. A method comprising:
for each of multiple billers, maintaining, at a payment system, a transaction record for each of one or more transactions for the biller, each transaction having been executed by or on behalf of a customer through a user interface of the payment system; and
updating, at the payment system, a confirmation status of a particular transaction record for a particular biller based on a confirmation received from the particular biller.

2. The method of claim 1, comprising sending, to the particular biller, transaction data for the transaction corresponding to the particular transaction record.

3. The method of claim 2, comprising receiving the confirmation from the particular biller responsive to the sent transaction data.

4. The method of claim 2, comprising sending the transaction data upon execution of the transaction.

5. The method of claim 2, wherein the transaction data include at least some of the data in the transaction record for the transaction.

6. The method of claim 1, wherein the confirmation is indicative of whether the biller received transaction data for the transaction corresponding to the particular transaction record.

7. The method of claim 1, wherein the confirmation is indicative of an error associated with the particular transaction record or the transaction corresponding to the particular transaction record.

8. The method of claim 7, wherein the error includes that the transaction is a duplicate transaction or that the transaction record is a duplicate transaction record.

9. The method of claim 1, comprising providing, to a customer service representative, information indicative of the confirmation status of the particular transaction.

10. A computer readable storage medium storing instructions for causing a computing system to:
for each of multiple billers, maintain, at a payment system, a transaction record for each of one or more transactions for the biller, each transaction having been executed by or on behalf of a customer through a user interface of the payment system; and
update, at the payment system, a confirmation status of a particular transaction record for a particular biller based on a confirmation received from the particular biller.

11. The computer readable storage medium of claim 10, wherein the instructions cause the computing system to send, to the particular biller, transaction data for the transaction corresponding to the particular transaction record.

12. The computer readable storage of claim 11, wherein the instructions cause the computing system to receive the confirmation from the particular biller responsive to the sent transaction data.

13. The computer readable storage of claim 11, wherein the instructions cause the computing system to send the transaction data upon execution of the transaction.

14. A computing system comprising:
a processor coupled to a memory, the processor and memory configured to:
for each of multiple billers, maintain, at a payment system, a transaction record for each of one or more transactions for the biller, each transaction having been executed by or on behalf of a customer through a user interface of the payment system; and
update, at the payment system, a confirmation status of a particular transaction record for a particular biller based on a confirmation received from the particular biller.

15. The computing system of claim 14, wherein the processor and memory are configured to send, to the particular biller, transaction data for the transaction corresponding to the particular transaction record.

16. The computing system of claim 15, wherein the processor and memory are configured to receive the confirmation from the particular biller responsive to the sent transaction data.

17. The computing system of claim 15, wherein the processor and memory are configured to send the transaction data upon execution of the transaction.

18. A method comprising:
for each of multiple billers, maintaining, at a payment system, a transaction record for each of one or more transactions for the biller, each transaction having been executed by a customer through a user interface of the payment system; and
enabling display, to or for the benefit of a particular biller, one or more of the transaction records for the particular biller.

19. The method of claim 18, wherein enabling display of the transaction records comprises enabling display of the transaction records to or for the benefit of the particular biller and not to or for the benefit of any other of the multiple billers.

20. The method of claim 18, wherein enabling display of the transaction records comprises enabling the transaction records to be displayed within a third party software interface.

21. The method of claim 18, wherein enabling display of the transaction records comprises enabling an interaction with the transaction records on behalf of the particular biller.

22. The method of claim 18, wherein each transaction record includes a confirmation status for the corresponding transaction.

23. The method of claim 22, wherein enabling display of the transaction records includes enabling display of the confirmation status for each transaction record.

24. The method of claim 22, wherein enabling display of the transaction records includes enabling sorting of the transaction records by confirmation status.

25. The method of claim 22, wherein the confirmation status is based on a confirmation received from or on behalf of the biller of the corresponding transaction.

26. The method of claim 25, wherein the confirmation received from or on behalf of the biller is indicative of whether the biller received transaction data for the corresponding transaction.

27. The method of claim 25, wherein the confirmation received from or on behalf of the biller is indicative of an error associated with the corresponding transaction.

28. A computer readable storage medium storing instructions for causing a computing system to:
for each of multiple billers, maintain, at a payment system, a transaction record for each of one or more transactions for the biller, each transaction having been executed by a customer through a user interface of the payment system; and
enable display, to or for the benefit of a particular biller, one or more of the transaction records for the particular biller.

29. The computer readable storage medium of claim 28, wherein enabling display of the transaction records comprises enabling display of the transaction records to or for the benefit of the particular biller and not to or for the benefit of any other of the multiple billers.

30. The computer readable storage medium of claim 28, wherein enabling display of the transaction records comprises enabling the transaction records to be displayed within a third party software interface.

31. The computer readable storage medium of claim 28, wherein enabling display of the transaction records comprises enabling an interaction with the transaction records on behalf of the particular biller.

32. The computer readable storage medium of claim 28, wherein enabling display of the transaction records includes enabling display of a confirmation status for each transaction record.

33. The computer readable storage medium of claim 28, wherein enabling display of the transaction records includes enabling sorting of the transaction records by a confirmation status for each transaction record.

34. A computing system comprising:
a processor coupled to a memory, the processor and memory configured to:
for each of multiple billers, maintain, at a payment system, a transaction record for each of one or more transactions for the biller, each transaction having been executed by a customer through a user interface of the payment system; and
enable display, to or for the benefit of a particular biller, one or more of the transaction records for the particular biller.

35. The computing system of claim 34, wherein enabling display of the transaction records comprises enabling display of the transaction records to or for the benefit of the particular biller and not to or for the benefit of any other of the multiple billers.

36. The computing system of claim 34, wherein enabling display of the transaction records comprises enabling the transaction records to be displayed within a third party software interface.

37. The computing system of claim 34, wherein enabling display of the transaction records comprises enabling an interaction with the transaction records on behalf of the particular biller.

38. The computing system of claim 34, wherein enabling display of the transaction records includes enabling display of a confirmation status for each transaction record.

39. The computing system of claim 34, wherein enabling display of the transaction records includes enabling sorting of the transaction records by a confirmation status for each transaction record.

40. A method comprising:
receiving transaction data for a transaction executed by or on behalf of a customer through a user interface of a payment system; and
sending, to the payment system, a confirmation in response to receiving the transaction data.

41. The method of claim 40, wherein the confirmation is indicative of receipt of the transaction data.

42. The method of claim 40, wherein the confirmation is indicative of an error associated with the transaction data.

43. The method of claim 40, comprising evaluating a validity of the received transaction data.

44. The method of claim 43, wherein the confirmation is indicative of the validity of the received transaction data.

45. The method of claim 43, wherein evaluating the validity of the received transaction data comprises evaluating the received transaction data in view of stored transaction data.

46. The method of claim 40, comprising storing the received transaction data.

47. A computer readable storage medium storing instructions for causing a computing system to:
receive transaction data for a transaction executed by or on behalf of a customer through a user interface of a payment system; and
send, to the payment system, a confirmation in response to receiving the transaction data.

48. The computer readable storage medium of claim 47, wherein the instructions cause the computing system to evaluate a validity of the received transaction data, and wherein the confirmation is indicative of the validity of the received transaction data.

49. The computer readable storage medium of claim 47, wherein the instructions cause the computing system to store the received transaction data.

50. A computing system comprising:
a processor coupled to a memory, the processor and memory configured to:
receive transaction data for a transaction executed by or on behalf of a customer through a user interface of a payment system; and
send, to the payment system, a confirmation in response to receiving the transaction data.

51. The computing system of claim 50, wherein the processor and memory are configured to evaluate a validity of the received transaction data, and wherein the confirmation is indicative of the validity of the received transaction data.

52. The computing system of claim 50, wherein the processor and memory are configured to store the received transaction data.

53. A method comprising:
receiving, from a payment system, a transaction record for each of one or more transactions for a biller, each transaction having been executed by a customer through the payment system; and
displaying one or more of the transaction records on a user interface.

54. The method of claim 53, wherein each transaction record includes a confirmation status for the corresponding transaction.

55. The method of claim 54, wherein displaying one or more of the transaction records includes displaying the confirmation status for each transaction record.

56. The method of claim 54, wherein the confirmation status is based on a confirmation status is based on a confirmation received from or on behalf of the biller.

57. The method of claim 56, wherein the confirmation status is indicative of whether the biller received transaction data for the corresponding transaction.

58. The method of claim 56, wherein the confirmation status is indicative of an error associated with the corresponding transaction.

59. The method of claim 54, wherein displaying one or more of the transaction records includes displaying transaction records having a particular confirmation status.

60. The method of claim 53, wherein displaying one or more of the transaction records includes displaying transaction records for transactions executed by or on behalf of a particular customer or transaction records for transactions corresponding to a particular customer account identifier.

61. The method of claim 53, comprising requesting the transaction records from the payment system.

62. The method of claim 61, wherein requesting the transaction records includes requesting transaction records for transactions executed by or on behalf of a particular customer or transaction records for transactions corresponding to a particular customer account identifier.

63. The method of claim 61, wherein requesting the transaction records includes requesting transaction records having a particular confirmation status.

64. A computer readable storage medium storing instructions for causing a computing system to:
receive, from a payment system, a transaction record for each of one or more transactions for a biller, each transaction having been executed by a customer through the payment system; and
display one or more of the transaction records on a user interface.

65. The computer readable storage medium of claim 64, wherein the instructions cause the computing system to display one or more of the transaction records includes displaying a confirmation status for each transaction record.

66. The computer readable storage medium of claim 64, wherein the instructions cause the computing system to display one or more of the transaction records includes displaying transaction records having a particular confirmation status.

67. The computer readable storage medium of claim 64, wherein the instructions cause the computing system to display one or more of the transaction records includes displaying transaction records for transactions executed by or on behalf of a particular customer or transaction records for transactions corresponding to a particular customer account identifier.

68. The computer readable storage medium of claim 64, wherein the instructions cause the computing system to request the transaction records from the payment system.

69. A computing system comprising:
a processor coupled to a memory, the processor and memory configured to:
receive, from a payment system, a transaction record for each of one or more transactions for a biller, each transaction having been executed by a customer through the payment system; and
display one or more of the transaction records on a user interface.

70. The computing system of claim 69, wherein the processor and memory are configured to display one or more of the transaction records includes displaying a confirmation status for each transaction record.

71. The computing system of claim 69, wherein the processor and memory are configured to display one or more of the transaction records includes displaying transaction records having a particular confirmation status.

72. The computing system of claim 69, wherein the processor and memory are configured to display one or more of the transaction records includes displaying transaction records for transactions executed by or on behalf of a particular customer or transaction records for transactions corresponding to a particular customer account identifier.

73. The computing system of claim 69, wherein the processor and memory are configured to request the transaction records from the payment system.
